(19) United States
(12) Patent Application Publication
(10) Pub. No.: US 2013/0093332 A1
(43) Pub. Date: Apr. 18, 2013

(54) INTELLIGENT LED LAMP GROUP CONTROL DEVICE USING EXISTING WALL SWITCH

(71) Applicants: Cheng-Liang Lee, New Taipei (TW); Hsi Alex Chang, New Taipei (TW); Hsuan-Chieh Hsiang, New Taipei (TW); Ming-Wei Hong, New Taipei (TW); Jen-Yu Tseng, New Taipei (TW)

(72) Inventors: Cheng-Liang Lee, New Taipei (TW); Hsi Alex Chang, New Taipei (TW); Hsuan-Chieh Hsiang, New Taipei (TW); Ming-Wei Hong, New Taipei (TW); Jen-Yu Tseng, New Taipei (TW)

(73) Assignee: ENERGY INTELLIGENCE CORPORATION, New Taipei (TW)

(21) Appl. No.: 13/274,299

(22) Filed: Oct. 14, 2011

(51) Int. Cl. H05B 37/02

(52) U.S. Cl. 315/154

(57) ABSTRACT

An intelligent LED lamp group control device using an existing wall switch for controlling a group of LED lamps includes an AC power converter, an interface for intelligent control using an interface circuit for upgrading the existing wall switch for scene group control. The device further includes a night lamp control input port, an emergency operation switch, an external set control box connector, a wall switch input unit, a control configuration set interface, a power failure battery input port and a night lamp and RS-485 serial port. The device enables one single controller to achieve control of and provide power supply to multiple LED lamps, and uses a communication control interface for converting the power supply originally provided to the LED lamps into a logic control signal so that the wiring layout and location of the original lighting control wall switch can be used.

### BACKGROUND OF THE INVENTION

(a) Field of the Invention

The present invention relates to lighting control technology and more particularly, to an intelligent LED lamp group control device, which uses the wiring layout and location of an existing lighting control wall switch to achieve an intelligent LED lamp group control by means of a specially designed circuit structure without making any wiring layout modification.

(b) Description of the Prior Art

Conventional wall-mount lamp control switches are so designed that one switch controls one lamp or a number of lamps. In case LED lamps are used, the functioning of conventional wall-mount lamp control switches remains unchanged. If going to change the LED lamp control contents, the wiring layout must be re-arranged. After installation of the wiring layout, the wall switch control content is fixed and not freely adjustable. A new wiring layout must be made if any change of the wall switch control content is required. Using wall-mount lamp control switches in this manner is inconvenient and may cause waste.

### SUMMARY OF THE INVENTION

The present invention has been accomplished under the circumstances in view. It is one object of the present invention to provide an intelligent LED lamp group control device, which can use the wiring layout of an existing lighting control wall switch to achieve intelligent LED lamp group control by converting the power supply that is originally provided to the LED lamps controlled by the existing lighting control wall switch into a logic control signal without any extra wiring or operating interface and, which provides an internal DIP switch or attached external controller for group scene configuration setting without making any extra wiring work.

It is another object of the present invention to provide an intelligent LED lamp group control device, which provides a night lamp linking energy-saving control interface that accepts the wiring layout of the existing lighting control wall switch and can directly convert the power supply into a logic control signal for controlling all linked controllers so that all the LED lamps can be changed into a night lamp mode by means of a group scene setting and the LED lamps that are not set to perform the night lamp mode will be turned off. In other words, one single wall switch can control all the LED lamps in the whole luminous area, turning off all the other LED lamps and simply keeping the assigned LED lamp(s) for illumination.

It is still another object of the present invention to provide an intelligent LED lamp group control device, which uses an external battery for emergency lighting, enabling the LED lamps to consume battery power supply upon a power failure, and, which controls charging and discharging of the attached external battery avoiding overcharge or over-discharge. The intelligent LED lamp group control device rapidly and accurately detects a power failure signal and automatically switches the LED lamps into a night lamp mode and connects the battery power supply from the attached external battery to the LED lamp at each intersection for lighting and at the same time, turns off the other LED lamps, saving power consumption and extending the service time of the attached external battery.

It is still another object of the present invention to provide an intelligent LED lamp group control device, which uses a passive infrared sensor to sense the approaching of a human body and to automatically control the operation of the LED lamps subject to the sensing operation of the passive infrared sensor. By means of connecting the output power supply of the passive infrared sensor to the auto lighting control interface and making a group scene setting, each LED lamp is individually controlled.

It is still another object of the present invention to provide an intelligent LED lamp group control device, which provides an interface for remote power measurement reading and inquiring control, enabling the power consumption data and operation status data of the LED lamps to be recorded and reported to a remote system control center. Thus, the invention works as a platform for enabling any of a variety of communication interfaces, such as cell phone or mobile PC to be connected to the remote system control center for real-time or timely control of the LED lamps or for inquiring the power consumption data or the operation status of the LED lamps.

### BRIEF DESCRIPTION OF THE DRAWINGS

FIG. 1 illustrates the outer appearance of an intelligent LED lamp group control device and the attached operating interface devices in accordance with the present invention.

FIG. 2 is a system block diagram illustrating an application example of the present invention.

FIG. 3 is an exploded view of the main controller of the intelligent LED lamp group control device in accordance with the present invention.

FIG. 4 is a system block diagram of the intelligent LED lamp group control device in accordance with the present invention.

FIG. 5(a)˜5(d) is a circuit diagram of the main controller in accordance with the present invention.

FIG. 6(a)˜6(b) is a circuit diagram of the attached intelligent operation and control device of the intelligent LED lamp group control device in accordance with the present invention.

FIG. 7 is a circuit diagram of the external set control box attached to the intelligent LED lamp group control device in accordance with the present invention.

### DETAILED DESCRIPTION OF THE PREFERRED EMBODIMENTS

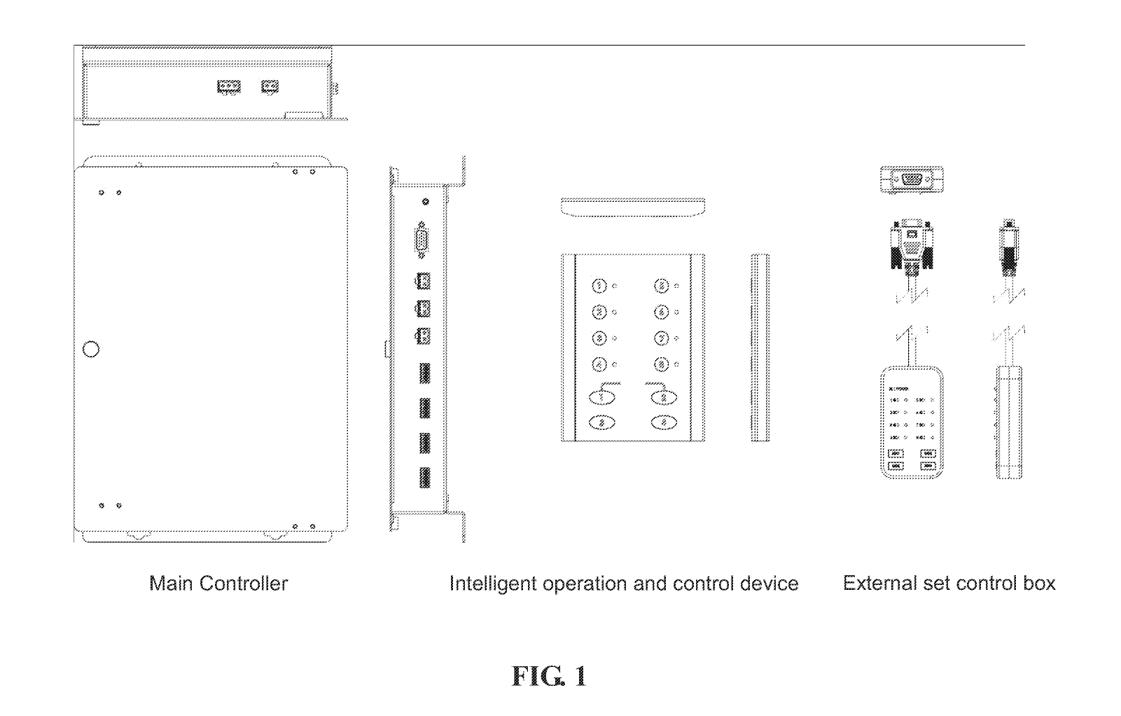

FIG. 1 illustrates the outer appearance of an intelligent LED lamp group control device and the attached intelligent operation and control device and external set control box in accordance with the present invention.

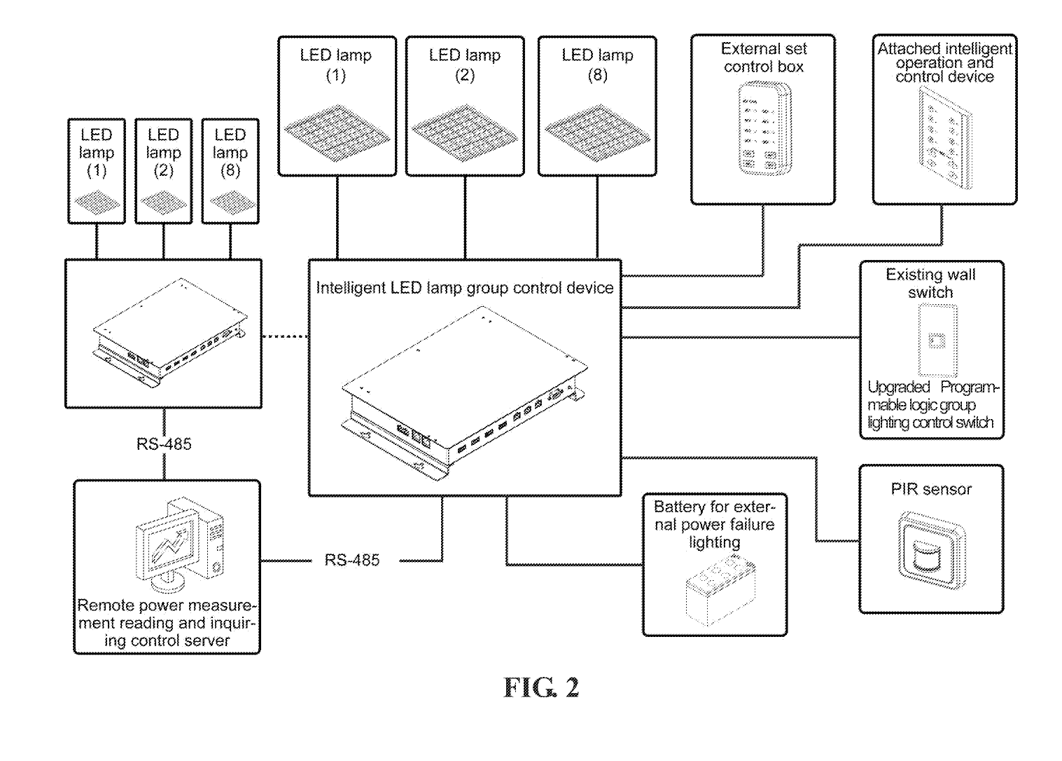

FIG. 2 is a system block diagram illustrating an application example of the present invention. As illustrated, the invention can control and provide power supply to 8 pcs of LED lamps. The external set control box is connected to the main controller by a cable for setting the content of group configuration. Further, the attached intelligent operation and control device can substitute for the existing wall switch to provide an intelligent operation and control interface or upgrade the original wall switch into a programmable logic LED lamp group control switch. Further, the intelligent LED lamp group control device can be coupled with an external passive infrared sensor and an external power failure lighting fixture and linked to a remote power measurement reading and inquiring control server.

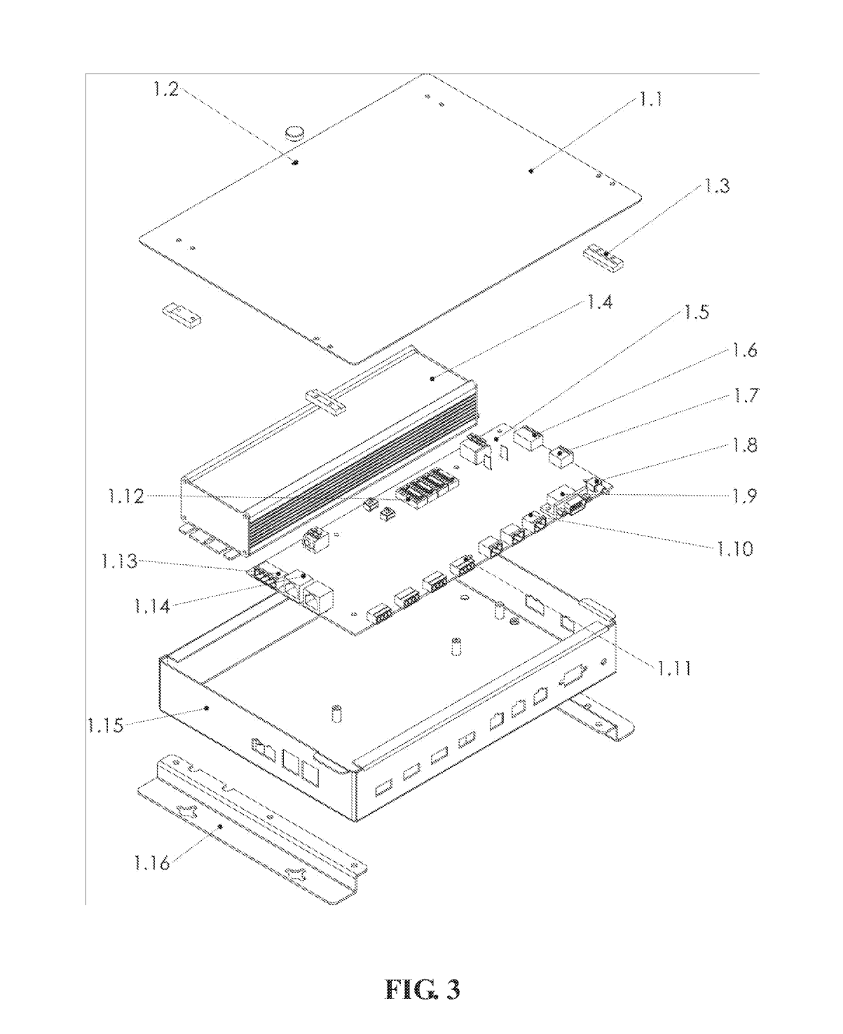

FIG. 3 is an exploded view of the main controller of the intelligent LED lamp group control device in accordance with the present invention. As illustrated, the main controller comprises a controller top cover 1.1, an external LED lamp power drive port unit 1.11, a DC power converter 1.4, a controller main board 1.5, a controller casing 1.15 that accommodates the DC power converter 1.4 and the controller main board 1.5, and a bracket 1.16.

The controller top cover 1.1 has an extended surface area, providing waterproof, dustproof and heat dissipation effects.

Further, the controller top cover 1.1 has a mounting through hole 1.2 for receiving a thumbscrew, facilitating mounting and dismounting and internal setting.

Further, top cover guide blocks 1.3 are set between the controller top cover 1.1 and the controller casing 1.15, facilitating mounting and dismounting of the controller top cover 1.1.

The DC power converter 1.4 provides the necessary working voltage to multiple LED lamps, saving the cost.

The controller main board 1.5 is adapted for the linking of operation and control interfaces, comprising an AC power input port 1.6, a night lamp control input port 1.7, an emergency operation switch 1.8, an external set control box connector 1.9, a wall switch input unit 1.10, a control configuration set interface 1.12, a power failure battery input port 1.13 and a night lamp and RS-485 serial port 1.14.

The AC power input port 1.6 is a city power supply interface.

The night lamp control input port 1.7 is directly connectable to the power supply of an existing lighting control switch for converting the power supply of the existing lighting control switch into a digital signal for night lamp control.

The emergency operation switch 1.8 is adapted for switching between different power sources and emergency application.

The external set control box connector 1.9 is connected to the external set control box by a 15-core cable for group configuration setting and a simple one-to-one lighting control.

The wall switch input unit 1.10 provides three ports for the input of the power supply of existing lighting witches or passive infrared sensor and adapted for converting inputted power supply signals into logic digital signals.

The external LED lamp power drive port unit 1.11 includes four sets of ports, each set consisting of two ports. Thus, the external LED lamp power drive port unit 1.11 can provide power supply to total 8 pcs of LED lamps and coupled with them for power control and measurement.

The control configuration set interface 1.12 is an interface adapted for setting group configurations. The group configuration setting can also be done by means of an internal DIP switch.

The power failure battery input port 1.13 is adapted for allowing an external battery to provide the necessary working voltage in case of power failure and driving the connected LED lamps to work in a night lamp group mode, thereby extending battery service time. Further, the power failure battery input port 1.13 also provides a charging/discharging control protection function.

The night lamp and RS-485 serial port 1.14 works as an interface for night lamp linking control and RS-485 remote power measurement reading and inquiring control communication.

The controller casing 1.15 accommodates the DC power converter 1.4 and the controller main board 1.5. The DC power converter 1.4 provides the necessary working voltage to multiple LED lamps.

The bracket 1.16 matches with the controller casing 1.15 for on-site installation and heat dissipation.

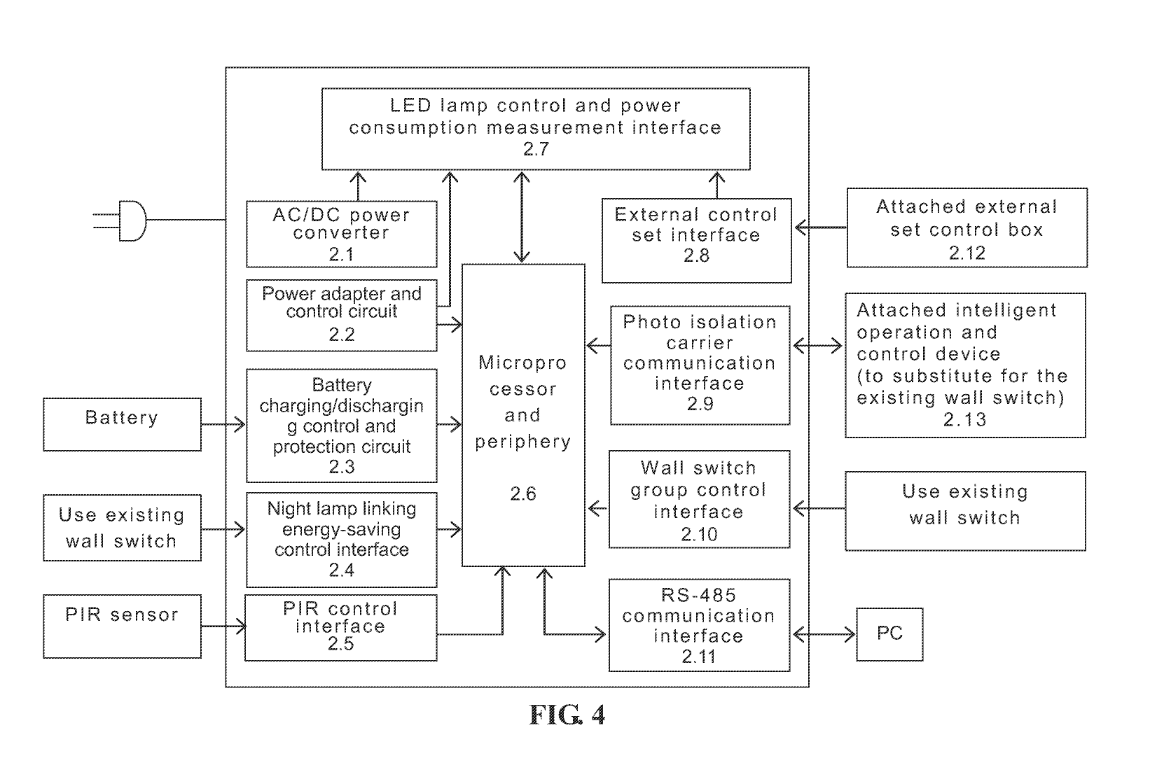

FIG. 4 is a system block diagram of the intelligent LED lamp group control device in accordance with the present invention. As illustrated, city power supply is inputted into the intelligent LED lamp group control device through AC/DC power converter 2.1, which outputs DC power supply partially to LED lamp control and power consumption measurement interface 2.7 for driving LED lamps directly, and partially to power adapter and control circuit 2.2 for converting into different voltages, for example, battery charging voltage, 5V working voltage, 24V relay voltage and 9V drive voltage.

The battery charging/discharging control and protection circuit 2.3 allows for the setting of one of a series of battery charging upper limit voltages and one of a series of battery discharging lower limit voltages to keep the battery in the full power condition without overcharge. In case of power failure, the battery charging/discharging control and protection circuit 2.3 immediately detects and the situation, and then directly jumps to a night lamp group scene mode and controls a relay to let an external battery power supply substitute for the output of the AC/DC power converter 2.1, and at the same time, starts a battery discharge lower limit voltage comparator circuit, which automatically turns off the battery power supply when its discharge voltage reaches the set lower limit.

The night lamp linking energy-saving control interface 2.4 accepts the existing wall switch control and directly converts it into a night lamp group scene mode, and is controllable by a wall switch of the linked main control end. After the night lamp power-saving function is started, the microprocessor and periphery 2.6 turns off the major part of the LED lamps and keeps turning on the limited number of LED lamps that have been set into the night lamp mode subject to the predetermined night lamp setting, maintaining the necessary passageway lighting.

The passive infrared (PIR) control interface 2.5 is adapted for obtaining a control signal from the output power of a passive infrared sensor via a photo isolation circuit, and then provides the control signal to the microprocessor and periphery 2.6, and then controls the LED lamp corresponding to the passive infrared sensor that senses the approaching or departure of a human body.

The microprocessor and periphery 2.6 has software and memory built therein for reading various group scene input signals from blocks 2.4/2.5/2.9/2.10, and then drives the LED lamp control and power consumption measurement interface 27, subject to the group scene settings in the memory, to turn on/off each LED lamp and to measure the power consumption of each LED lamp and to further provide a measured data to a remote server through the RS-485 communication interface 2.11.

The LED lamp control and power consumption measurement interface 2.7 comprises a drive circuit consisting of 8 power MOSFETs (metal-oxide semiconductor field effect transistors), voltage measurement circuit, a current measurement and converter circuit and a status reading interface. By means of a series-in/parallel-out control IC, the microprocessor and periphery 2.6 controls every power MOSFET of the LED lamp control and power consumption measurement interface 2.7 to turn on/off each LED lamp, and to synthesize the current LED drive voltage into a drive current. Subject attenuation and amplification at a proper ratio, the A/D interface of the microprocessor and periphery 2.6 measures and converts the voltage (V) and electric current (A), and calculates the power (W) and the electric energy (Wh) consumed by each LED lamp. At final, by means of a parallel-in/series-out control IC, the LED lamp control and power consumption measurement interface 2.7 reads in the status of each LED lamp, recognizing the sources of the resultant electric currents for accurate recording individually.

The external control set interface 2.8 is designed subject to the configuration of the attached external set control box 2.12. When AC/DC power converter 2.1 is normal but not usable, the power switch of the attached external set control box 2.12 is started. At this time, the series-in/parallel-out control IC of the microprocessor and periphery 2.6 disables the LED lamp control IC, i.e., let the external set control box to take over the LED lamp On/Off control right. The external control set interface 2.8 provides the attached external set control box 2.12 with the necessary working power supply, allowing manual operation of each switch to control On/Off of each respective LED lamp for emergency application. By means of this interface, group configuration setting can be done from the outside.

The photo isolation carrier communication interface 2.9 matches the attached intelligent operation and control device 2.13, which uses the wiring layout and positions of the existing wall light control switches. This photo isolation carrier communication interface 2.9 utilizes the wiring layout of the existing two-line switch circuit. When reaching the peak value during the positive half cycle, the attached intelligent operation and control device 2.13 directly load the control signal onto the carrier wave, enabling the photo isolation carrier communication interface 2.9 to get the data from the carrier wave by photo isolation. The data thus obtained from the attached intelligent operation and control device is then decoded by the microprocessor and periphery 2.6 for controlling On/Off of the LED lamps, achieving intelligent LED lamp control by using the existing switch.

The wall switch group control interface 2.10 receives On/Off data from the existing wall switches. By means of photo isolation, the On/Off status of the existing wall switch is known, i.e., it converts power On-Off signal into logic Hi-Low signal, and then provides the signal to the microprocessor and periphery 2.6 for reading and further LED lamp On/Off control. Thus, the existing wiring layout and switches can be used for group scene control without making any change.

The RS-485 communication interface 2.11 is adapted for converting a UART signal from the microprocessor and periphery 2.6 into a RS-485 signal for connection with a remote server by a differential method, achieving remote inquiry and control.

The attached external set control box 2.12 is coupled to the external control set interface 2.8 by means of a 15-core cable for manual control of the power switches thereof to take over the LED lamp On/Off control right. The power switches of the attached external set control box 2.12 are manually operable to control On/Off of the LED lamps in a one-to-one manner. Further, the attached external set control box 2.12 allows the content of external group configuration setting to be stored in the memory of the microprocessor and periphery 2.6.

The attached intelligent operation and control device 2.13 works by using the wiring layout and location of the existing wall switch. This attached intelligent operation and control device 2.13 is made in the form of a box subject to the size of the wall switch for obtaining the necessary working power supply from the two wires of the existing wall switch and loading the LED lamp control signal onto the carrier wave at about 90° electrical angle during the positive half cycle of the sine wave so that the external control set interface 2.8 can receive the control signal and the microprocessor and periphery 2.6 can decode the control signal and control the LED lamps, achieving intelligent control without changing the existing wiring layout.

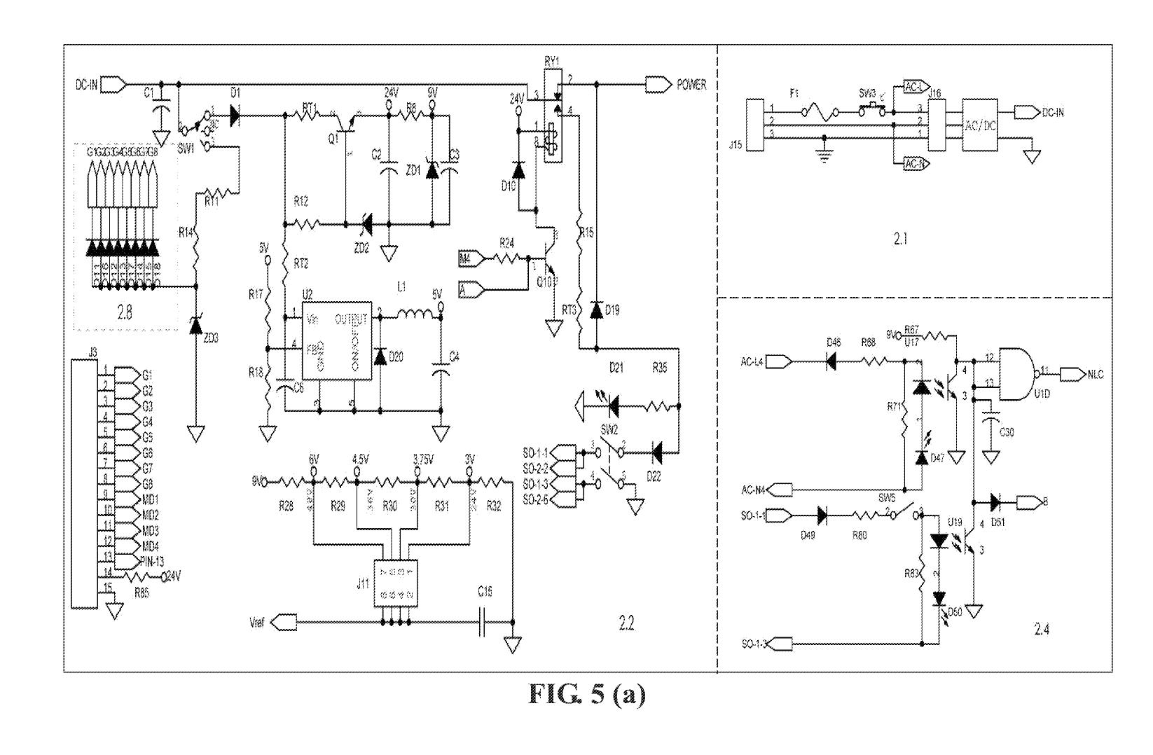

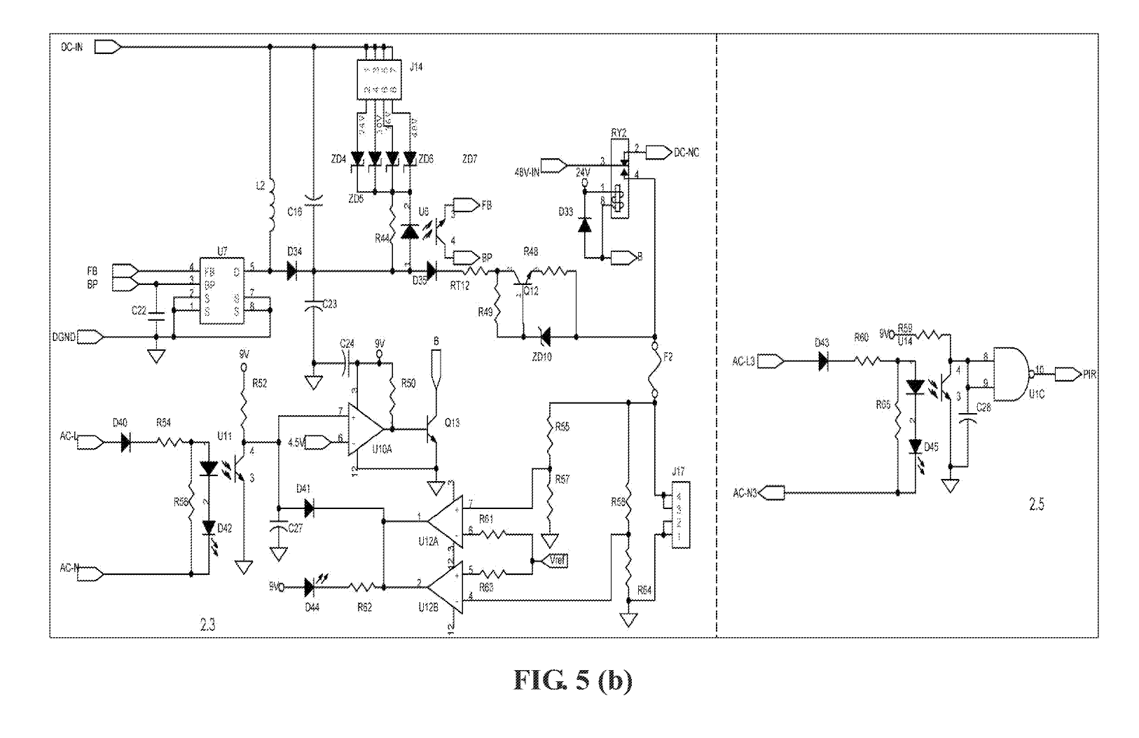

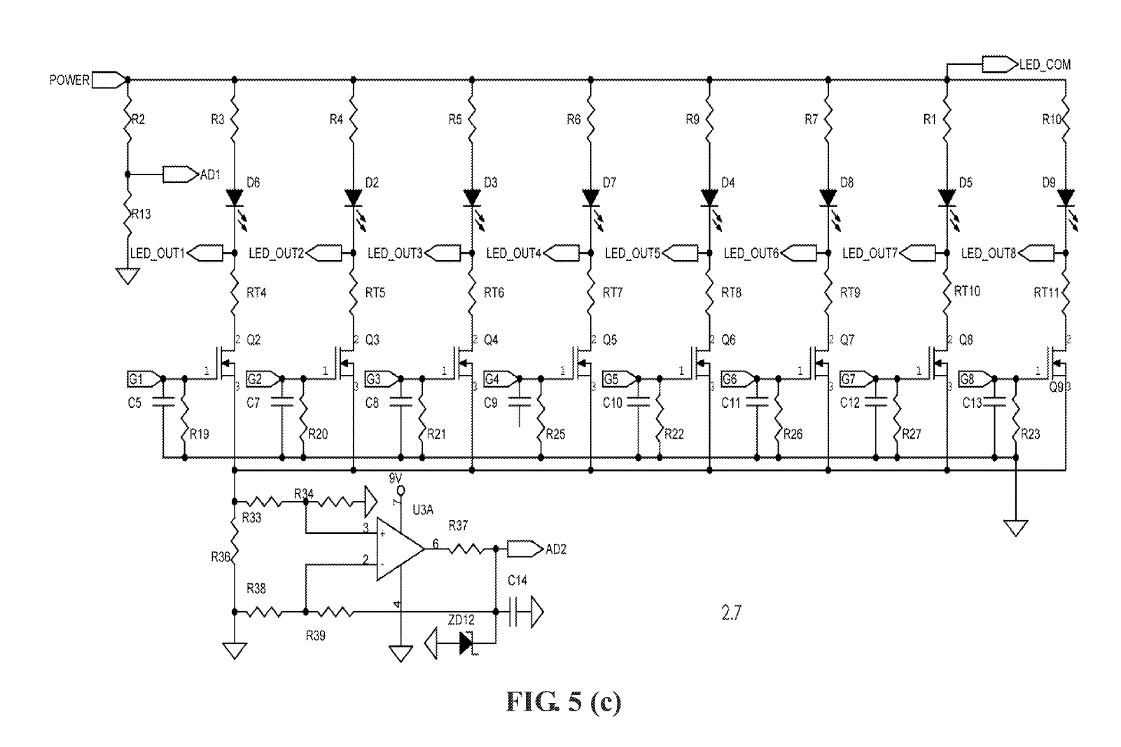

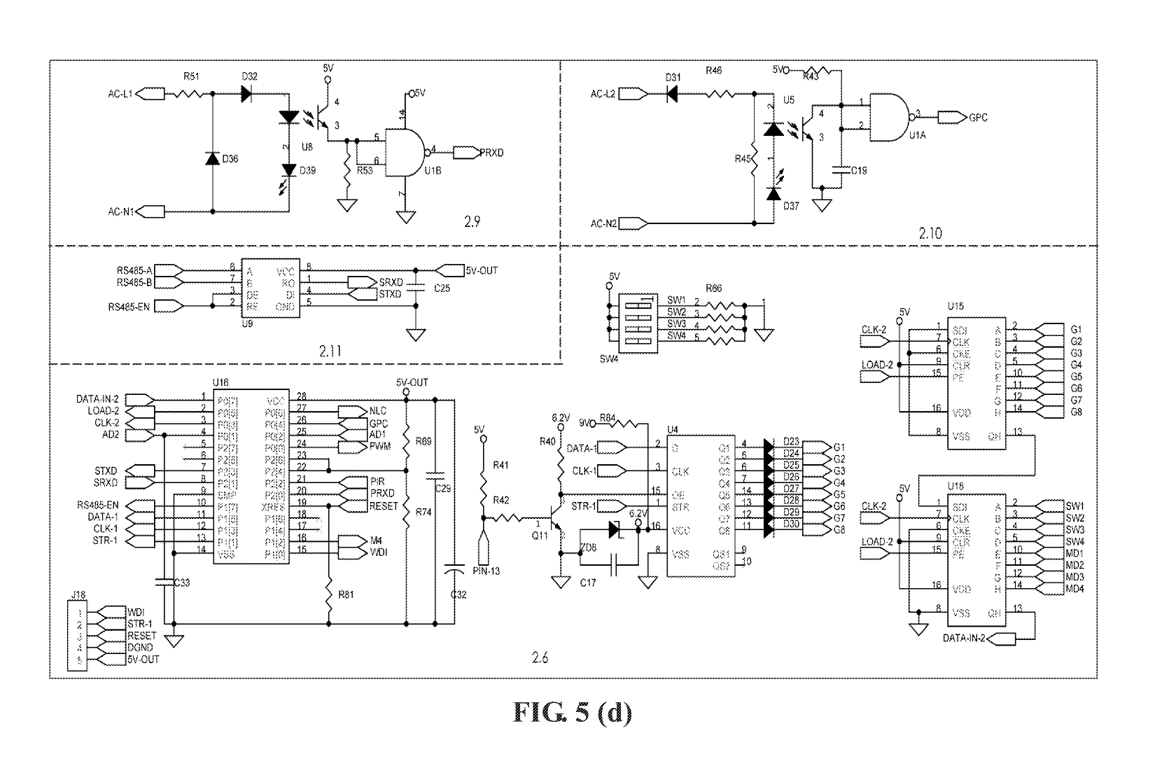

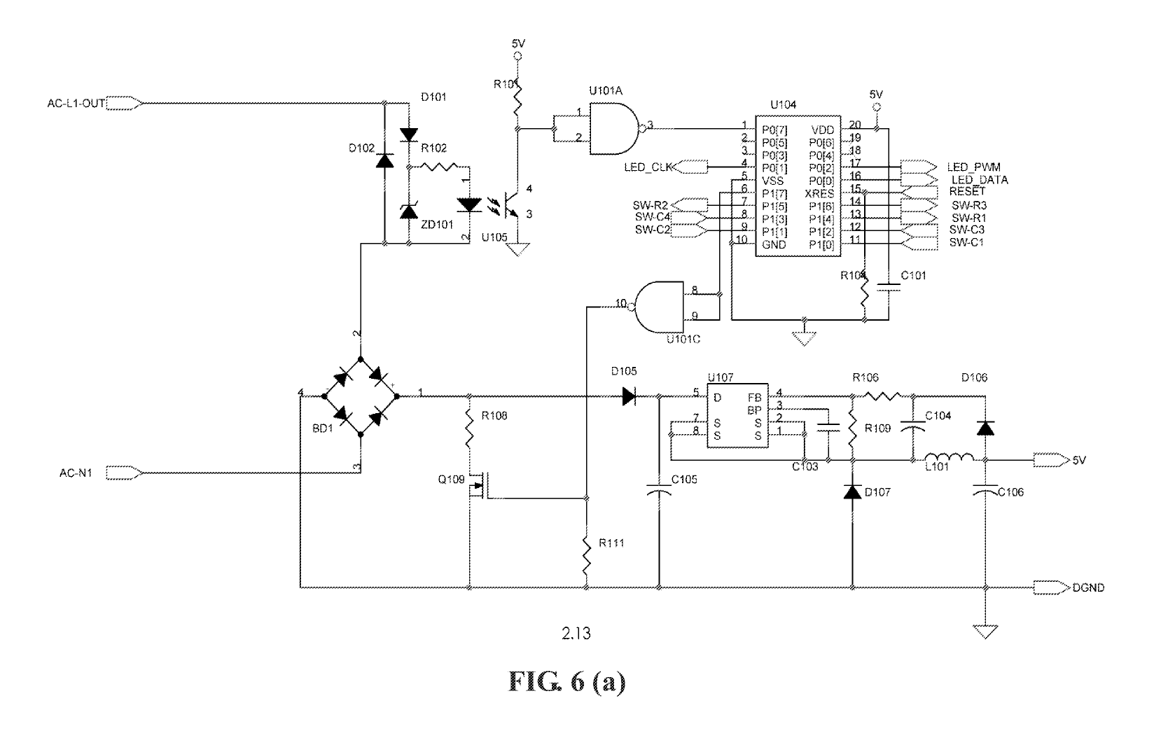

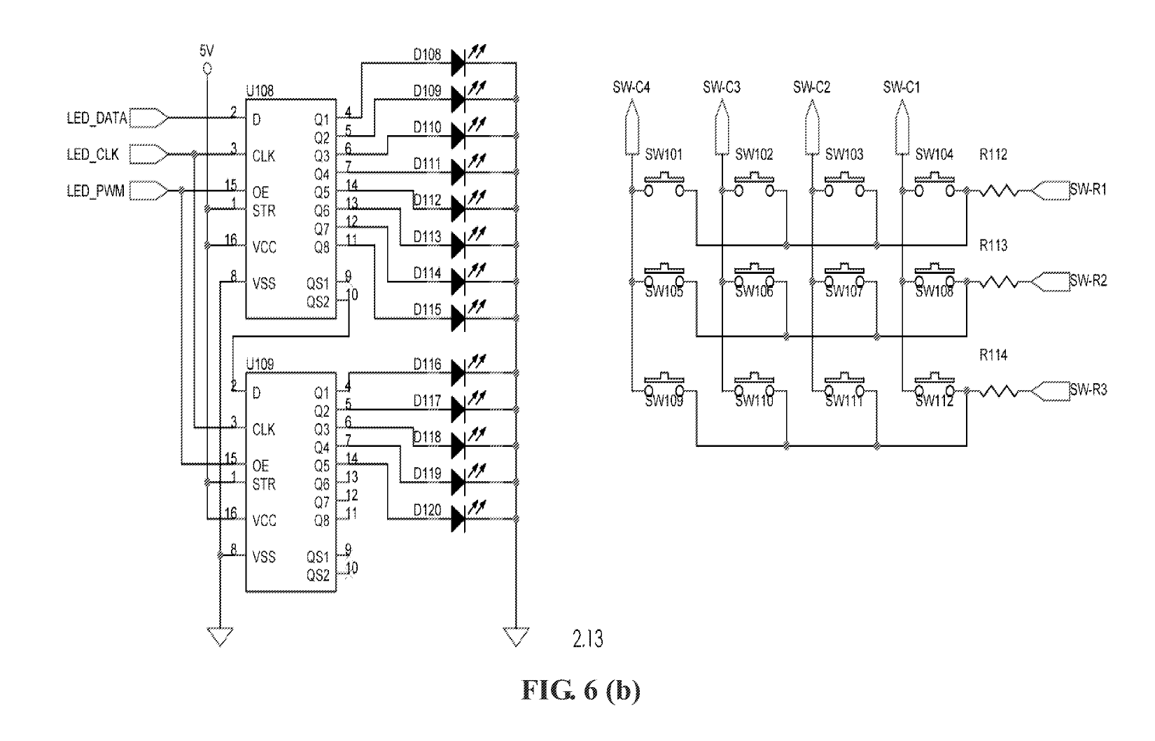

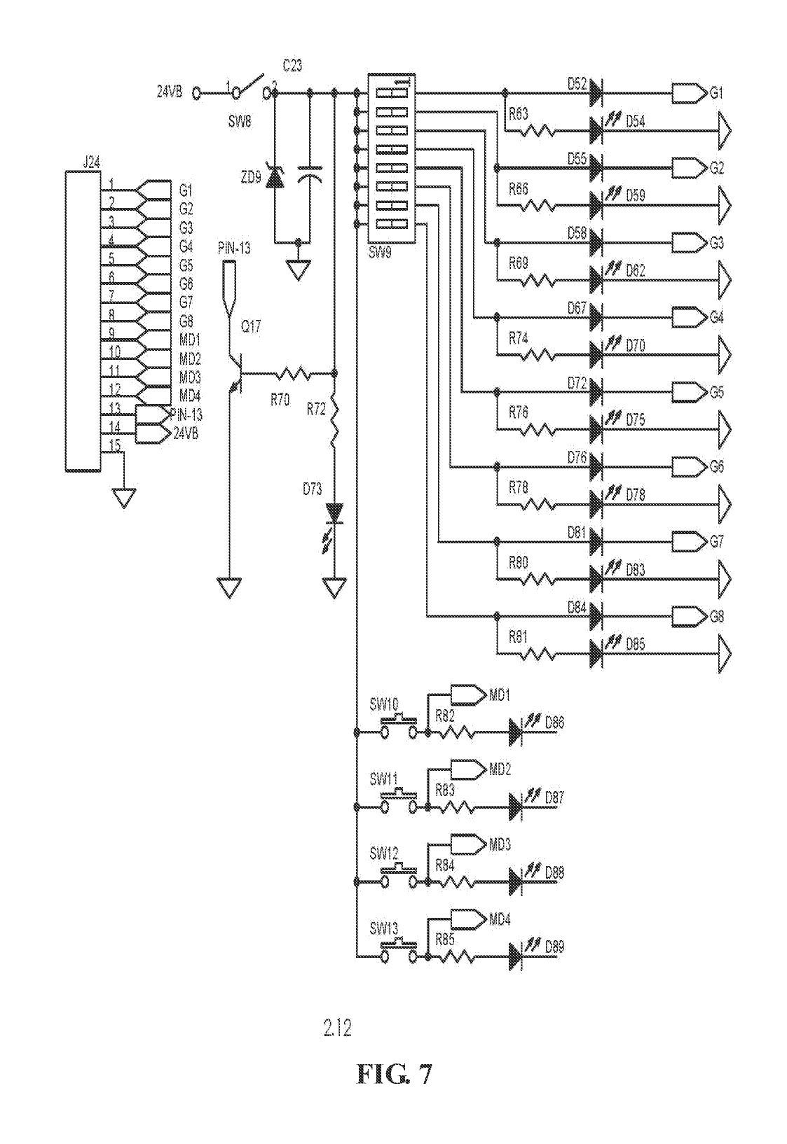

The operational principle and effects of the present invention will now be described hereinafter with reference to the circuit diagram of the main controller shown in FIG. 5(a)˜5(d), the circuit diagram of the attached intelligent operation and control device shown in FIG. 6(a)˜6(b) and the circuit diagram of the external set control box shown in FIG. 7.

As shown in FIG. 5(a), the AC/DC power converter 2.1 works in such a manner that city power supply is connected to a terminal J15 and transmitted through a fuse F1 and a temperature protection switch SW2 to an input terminal J16 of the AC/DC power converter 2.1. The output DC power supply of the AC/DC power converter 2.1 is provided for the controller. The terminals AC-L and AC-N shown in the drawings are connected to the battery charging/discharging control and protection circuit 2.3 for power failure detection.

As shown in FIG. 5(a), the power adapter and control circuit 2.2 works in such a manner that power supply is inputted through an input terminal DC-IN to a capacitor C1 and then to a switch SW1 for three-step selection, for example, when the terminal 1-2 at one of the three positions is conducted when power supply is normal, and power supply is inputted into a diode D1 for further distribution to satisfy different power supply requirements; when the terminal 2-3 at another of the three positions is conducted, it means the controller fails, and at this time, power supply is provided through resistors R11 and R14 and stabilized by a Zener diode ZD3 and then transmitted through diodes D11˜D18 for controlling the respective power MOSFETs to turn on the respective LED lamps. The other of the three positions of the switch SW1 is the power OFF position on the middle.

When the supply of the power supply is normal, the power supply is inputted through the diode D1 and stabilized through a resistor R12 and a Zener diode ZD2 and then processed through a resistor RT1 and a transistor Q1 to provide stabilized 24V voltage, that is then processed through a resistor R8 and a Zener diode ZD1 into 9V voltage. Further, the input power supply is also transmitted through a resistor RT2 to a voltage regulator IC U2 and then processed by resistors R17 and R18 subject to a predetermined ratio into 5V voltage for the microprocessor and periphery. Further, 9V voltage thus obtained is shunt through resistors R28, R29, R30, R31 and R32 into 6V, 4.5V, 3.75V and 3V and then selectively outputted through the terminal J11 for use as a reference voltage Vref for determination of the charging and discharging upper and lower limit voltages of the battery charging/discharging control and protection circuit 2.3. The corresponding battery voltages are 48V, 36V, 30V and 24V.

Further, the inputted power supply can be directly sent to a relay RY1 for providing to the LED lamps. The relay RY1 is controlled by a transistor Q10. When the transistor Q10 is ON, the input power supply is transmitted through resistors R15 and RT3 and a diode D19 to the LED lamps, limiting the supply of power supply to the LED lamps, i.e., simply providing a small amount of power supply to the LED lamps, enabling the LED lamps to work as night lamps.

When the relay RY1 is ON, i.e., when under the night lamp mode, the power supply is sent through a diode D22 to the switch SW2. When the switch SW2 is ON, i.e., when the terminal 2-3 and the terminal 4-5 are conducted, the power supply passes through SO-1 and SO-2 to a next controller. Subject to the functioning of the night lamp linking energy-saving control interface 2.4, the next LED lamp is controlled to perform the night lamp mode. Thus, when the switch SW2 is switched on, the present controller is defined to work as the main night lamp control switch for switching all the linked controllers into the night lamp mode.

As shown in FIG. 5(b), the battery charging/discharging control and protection circuit 2.3 works in such a manner that the terminal DC-IN is for charging of the attached external battery. Because the attached external battery uses the same voltage as the terminal DC-IN, the battery power supply is boosted by a voltage converter IC U7. The component referenced by J14 is adapted for controlling the upper limit voltage of the terminal DC-IN. The Zener diodes ZD4˜ZD6 are for stabilizing different voltage values. For example, if the battery voltage is 24V, the pin 1-2 of the component J14 is short-circuited, and at this time, the output voltage of the voltage converter IC U7, i.e., the upper limit voltage of the capacitor C23 is the voltage of the terminal DC-IN plus the voltage of the Zener diode ZD4; for the other 30V, 36V or 48V, the charging voltage is the voltage of the terminal DC-IN plus the voltage of the Zener diode ZD5, ZD6 or ZD7. Further, the external battery is connected to the connection port of the component J17. The aforesaid charging voltage is transmitted through a diode D35, a resistor RT12 and a transistor Q12 to charge the battery, wherein the circuit of the Zener diode, referenced by ZD10, and the resistor, referenced by R48, is for limiting the maximum charging current. The maximum charging voltage is limited by the voltage converter IC U7 and the Zener diods ZD4˜ZD7.

The photo isolator IC, referenced by U11 is adapted for power failure detection. When the power supply at the terminals AC-L and AC-N is off, the light-emitting diode, referenced by D42, receives no electric current, the collector electrode of the photo isolator IC U11, i.e., the PIN 7 of the component, referenced by U10A, is changed to HI, causing the component U10A to output HI to conduct a transistor Q13, driving a relay RY2 to work. Thus, the battery power supply from the attached external battery goes through the relay RY2 to the terminal DC-IN, i.e., the controller obtains the necessary working voltage from the attached external battery. At this time, the power failure signal is provided to a diode D51 to enter the nigh lamp mode, causing the relay RY1 to limit the supply of the power supply to the LED lamps, and therefore the attached external battery directly provides the battery power supply to the LED lamps, enabling the LED lamps to work for a long period of time under the night lamp mode. When the battery power is lowered during continuous operation, and dropped below the condition where the shunt voltage of the resistor R55 and the shunt voltage of the resistor R57 are below the selected reference voltage Vref, the output of the component, referenced by U12A, becomes LOW, and the diode, referenced by D41, is driven to change the pin 7 of the component U10A from HI to LOW, and therefore the transistor Q13 is OFF, and the relay RY2 is ON, stopping the supply of battery power supply and prohibiting an over-discharge.

As shown in FIG. 5(a), the night lamp linking energy-saving control interface 2.4 works in such a manner that the photo isolator IC, referenced by U17, is adapted for detecting the power supply of the existing wall switch. A regular wall switch is a two-way switch for lamp power supply control. The night lamp linking energy-saving control interface 2.4 detects the original power supply of the LED lamps, i.e., detecting the power supply at the terminals AC-L4 and AC-N4 to obtain a control signal. When the wall switch is ON, a light-emitting diode D47 is conducted, causing the output of the photo isolator IC U17, i.e., U1D-PINs 12 and 13 become LOW; on the contrary, when the wall switch is OFF, the output becomes HI. The output of the photo isolator IC U17 is connected from NLC to the microprocessor U16. (see FIG. 5d). Thus, the ON or OFF message of the existing wall switch is thus obtained, and can be converted into a night lamp mode switching command. The main feature of this design allows the existing wall switch to be used directly without changing or adding any wiring layout.

Further, the component, referenced by U19, is a night lamp linking control interface. When linking the present controller, the switch, referenced by SW5, is set into ON position, thus, when a power supply is inputted through components S01-1 and S01-3, it is controlled in the same manner as through the components AC-L3 and AC-N3 to change UID-PINs 12 and 13 from HI to LOW and NLC from LOW to HI, driving the component U16 to enter the night lamp mode. By means of the design of the present interface, one single wall switch can control the lightings of the whole building or whole floor into the night lamp mode, i.e., simply maintaining a minor amount of power supply and switching off the lighting power supply that is not cut off.

The passive infrared (PIR) control interface 2.5 shown in FIG. 5(b) uses a photo isolator IC U14 for converting a power supply into a control signal, allowing the power supply of the existing wall switch to be provided to a passive infrared sensor. When the passive infrared sensor detects the approaching of a human being, the passive infrared (PIR) control interface 2.5 immediately outputs power supply to the LED lamps. When passive infrared sensor detects a signal, the light-emitting diode, referenced by D45, is conducted, the collector electrode of the photo isolator IC U14, i.e., UIC-PINs 8 and 9 are changed from HI to LOW, the PIR output signal of U1C becomes HI, thereby informing the microprocessor U16 to start the PIR mode, turning on the LED lamp group.

As shown in FIG. 5(d), the microprocessor and periphery 2.6 works in such a manner that the microprocessor U16 recognize and process four control signals converted from the power supply of the wall switch, including the night lamp control signal NLC, the passive infrared control signal PIR, the scene group control signal GPC and the intelligent control signal PRXD. The content of the LED lamp lighting control of the above signals is determined subject to the content of the setting stored in the memory of the microprocessor U16. The microprocessor U16 reads in the content of components G1˜G8 and components MD1˜MD4 via parallel-in/series-out ICs U15 and U18, and then stores the data in its built-in memory. Further, two measurement signals, i.e., the voltage signal AD1 and the current signal AD2 are converted by the internal A/D converter circuit of the microprocessor U16 into respective digital data indicative of the drive voltage (V) and drive current (A) of the LED lamps for calculating the related power (W) and energy (Wh) consumed by means of an internal computing program. The computed data corresponding to the respective LED lamps is obtained through the parallel-in/series-out ICs U15 for recording and recognition, achieving failure report function. Further, by means of a series-in/parallel-out IC U4, the microprocessor U16 provides the respective LED lamp control signals through respective diodes D23˜D30 to the respective MOSFETs, i.e., Q2˜Q9 shown in the drawing. At final, the microprocessor U16 can read the content of setting of the communication ID, i.e., SW4 (RS-485 address) via the parallel-in/series-out IC U18, and communicate with a remote server through a RS-485 communication interface U9 for control and data storage.

Referring to FIG. 5(c), the LED lamp control and power consumption measurement interface 2.7 comprises 8 power MOSFET driving circuits consisting of field-effect transistors Q2˜Q9 each corresponding to one respective LED lamp, i.e., LED-OUT1˜OUT8. The first power MOSFET driving circuit is explained as an example. When the input of the terminal G1 is HI, the transistor Q2 is conducted. On the contrary, when the input of the terminal G1 is LOW, the transistor Q2 is OPEN. When the transistor Q2 is conducted, the corresponding indicator light D6 is ON, and the LED lamp that is connected to LED-COM and LED-OUT1 is turned on. The resistor, referenced by RT4, is a protective resistor. When overload, the resistor RT4 can overheat, increasing the impedance to limit the electric current passing therethrough. The other power MOSFET driving circuits work in the same manner. In the drawing, shunt resistors R2 and R13 are connected to the component AD1 for measuring the LED lamp drive voltage. The drive currents of the LED lamps are gathered and sent to a resistor R36. The component U3A is adapted for amplifying the voltage at the resistor R36, enabling the output voltage of the component U3A, i.e., the voltage of the component AD2 to be directly proportional to the resultant current of the LED lamps 1˜8, thus, by means of the internal A/D converter circuit of the microprocessor U16 through the components AD1 and AD2, the drive voltage (V), drive current (A), power (W) and energy consumed (Wh) of the LED lamps are known.

The external control set interface 2.8 provides a 15-pin connector having its PIN 1˜PIN 8 connected to the terminals G1˜G8 of the LED lamp control and power consumption measurement interface 2.7 for controlling the conduction of the respective transistors Q2˜Q9 and further controlling 8 external LED lamps that are respectively connected to the terminals LED-OUT1˜OUT8. The necessary 24V working power supply is obtained through resistor R85, and the control right is obtained through PIN 13 of the component J3, i.e., the PIN 13 of the component J3 is connected to the base electrode of the transistor Q11. Normally, the base electrode of the transistor Q11 is at HI, causing the collector electrode of the transistor Q11 to be changed to LOW. At this time, the output of the component U4 is controlled by the microprocessor IC U16. When the external set control box is started, the PIN 13 is changed to LOW, the output of the component U4 is disabled, and the LED lamp control right is handed to J13-1˜8 of the external control set interface 2.8 for emergency lighting control upon a circuit failure.

Further, the external control set interface 2.8 provides 4 scene group settings including 2 scene group settings for group lighting control, 1 scene group setting for PIR lighting control, and 1 scene group setting for night lamp control. The values of these settings are read from G1˜G8 and MD1˜MD4 by the microprocessor IC U16 by means of the parallel-in/series-out converter ICs U15 and U18, and then stored in its internal memory for controlling the operation of the LED lamps.

Referring to FIG. 5(d), the photo isolation carrier communication interface 2.9 uses a photo isolator IC U8 to detect a carrier signal during the positive half cycle. When the original wall switch is replaced by an intelligent operation and control device, the device modulates the peak of the positive half cycle into one byte of series communication signal UART. This transiently modulated signal, the communication signal that is changed from UART HI to UART LOW is changed to ON or OFF signal a the peak of the positive half cycle and exhibited at resistor R53 and then converted by U1B into a PRXD signal for recognition by the microprocessor U16 for intelligent LED lamp control.

Referring to FIG. 5(d), the wall switch group control interface 2.10 comprises a photo isolator IC U5 for converting the power supply of terminals AC-L2 and AC-N2 into a control signal, allowing the wiring and switching circuit of the existing lighting control wall switch to be directly used to provide the necessary working power supply to the LED lamps. AS shown in the drawing, the existing wall switch is connected to the terminals AC-L2 and AC-N2. When the wall switch is ON, the light-emitting diode D37 is conducted, the collector electrode of the component U5, i.e., U1-PIN 1 and PIN 2 become LOW, the GPC of the component U1A becomes HI, causing the microprocessor U16 to enter the scene group control mode.

Referring to FIG. 5(d), the RS-485 communication interface 2.11 comprises a RS-485 converter IC U9 adapted for converting the series communication signals of the microprocessor U16, i.e. SRXD and STXD signals into RS-485 differential signals, i.e., RS-485-A and RS-585-B signals for transmitting to a remove system control center, such as server or personal computer for enabling the remote control system to collect the power consumption data of the LED lamps and to control the operation of the LED lamps.

Referring to FIG. 6(a)˜6(b), the attached intelligent operation and control device uses the wiring layout and location of the existing lighting control wall switch, and has an outer appearance same as the original wall switch box. Its power supply and communication interface uses the two wires of the original wall switch. As shown in the drawing, the bridge rectifier, referenced by BD1, obtains power supply from the two-wire electrical line of the original wall switch and provided through the components D105 and C105 to the intelligent LED lamp group control device for working. The power converter IC, referenced by U107, is designed subject to the resistance value of the resistors R106 and R109 for converting city power supply into 5V. Further, the photo isolator IC, referenced by U105, detects the positive half cycle and negative half cycle of city power supply via the components D102, R102 and ZD101, and the detected positive half cycle signal and negative half cycle signal are inputted through the terminal U101-PIN 3 to the microprocessor U104 for use as a synchronous signal for signal transmission. In other words, the microprocessor U104 calculates the time base of the electrical angle of the peak of the positive half cycle of city power supply based on the signal time base of the terminal U101-PIN 3, and enables the signal to be transmitted to pass through the component U101 for driving a power MOSFET transistor Q109 to convert the digital signal into transient ON or OFF for carrying on the power cord, i.e., converting the digital signal to be transmitted into a pulse signal for the two-wire power cord. The current of this pulse is controlled by a resistor R8, and will be detected by the photo isolation carrier communication interface 2.9 and converted into original digital signal for recognition and execution by the microprocessor U16 to achieve intelligent LED lamp control. Further, components SW101˜SW108 are operation and control interfaces corresponding to the 8 LED lamps respectively; components SW109˜SW112 are scene group operation and control interfaces; components D108˜D120 are corresponding indicator lights controlled by the microprocessor U104 by means of series-in/parallel-out converter ICs U108 and U109, enhancing smart functioning of the intelligent LED lamp group control device without making any wiring layout modification.

Referring to FIG. 7, the attached external set control box 2.12 has the port J24 thereof connected to the port J3 of the external control set interface 2.8. When the switch SW8 is ON, the attached external set control box is started for setting and control. At this tie, the terminal PIN 13 becomes LOW, the LED lamp control IC U4 is disabled, and the LED lamp control right is handed to the attached external set control box 2.12. When biasing the switching levers 1˜8 of the switch SW9, the respective LED lamps 1˜8 are respectively turned on or off. Further, under a specific LED lamp lighting combination configuration, operating the components MD1˜MD4 causes the microprocessor U16 to memorize the set group configuration for further lighting control.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An intelligent LED lamp group control device, comprising a main controller, an attached intelligent operation and control device and an external set control box and adapted for controlling the operation of a plurality of LED lamps and providing power supply to said LED lamps, said external set control box being connected to said main controller for group configuration setting, said attached intelligent operation and control device being adapted for substituting the functioning of an existing wall switch to provide an intelligent operation and control interface.

2. The intelligent LED lamp group control device as claimed in claim 1, wherein said main controller comprises a controller top cover, a DC power converter, a controller main board and a controller casing, said controller casing accommodating said DC power converter and said controller main board.

3. The intelligent LED lamp group control device as claimed in claim 2, wherein said controller main board is connectable with a plurality of operation and control interfaces for controlling the operation of said LED lamps respectively, said controller main board comprising an AC power input jack, a night lamp control input port, an emergency operation switch, an external set control box connector, a wall switch input unit, a control configuration set interface, a power failure battery input port and a night lamp and RS-485 serial port.

4. The intelligent LED lamp group control device as claimed in claim 3, wherein said night lamp control input port s directly connectable to the power supply of an existing lighting control switch for converting the power supply of said existing lighting control switch into a digital signal for night lamp control.

5. The intelligent LED lamp group control device as claimed in claim 3, wherein said external set control box connector is connected to said external set control box for group configuration setting and a simple one-to-one lighting control.

6. The intelligent LED lamp group control device as claimed in claim 3, wherein said wall switch input unit comprises an input port for the input of the power supply of a passive infrared sensor for converting the inputted power supply signals from said passive infrared sensor into logic digital signals.

7. The intelligent LED lamp group control device as claimed in claim 3, wherein said control configuration set interface is adapted for setting group configurations by means of an internal DIP switch.

8. The intelligent LED lamp group control device as claimed in claim 3, wherein said night lamp and RS-485 serial port is an interface for night lamp linking control and RS-485 remote power measurement reading and inquiring control communication.

9. The intelligent LED lamp group control device as claimed in claim 3, wherein said wall switch input unit comprises a passive infrared (PIR) control interface adapted for obtaining a control signal from the output power of a passive infrared sensor via a photo isolation circuit, and then providing the control signal to a microprocessor and periphery, and then controlling said LED lamps corresponding to the passive infrared sensor that senses the approaching or departure of a human body subject to a predetermined group scene setting stored in said microprocessor and periphery.

10. The intelligent LED lamp group control device as claimed in claim 1, wherein said attached intelligent operation and control device uses the wiring layout and location of the existing wall switch to obtain the necessary working power supply from a 2-wire power cord and to load a LED lamp control signal onto the carrier wave at about 90-degrees electrical angle during the positive half cycle of the sine wave, enabling said external control set interface to receive the LED lamp control signal and said microprocessor and periphery to decode the LED lamp control signal and to execute the LED lamp control signal.
